(19) United States
(12) Patent Application Publication
(10) Pub. No.: US 2025/0173850 A1
(43) Pub. Date: May 29, 2025

(54) IMAGE FORMING APPARATUS, TERMINAL DEVICE, AND METHOD OF TRANSMITTING INFORMATION

(71) Applicant: SEIKO EPSON CORPORATION, Tokyo (JP)

(72) Inventors: Yuichi FURUWATA, SHIOJIRI-SHI (JP); Kazumasa KONDO, SHIOJIRI-SHI (JP)

(21) Appl. No.: 18/962,487

(22) Filed: Nov. 27, 2024

(30) Foreign Application Priority Data
Nov. 29, 2023 (JP) 2023-201434

(51) Int. Cl. G06T 7/00

(52) U.S. Cl. CPC G06T 7/0002; G06T 2207/30168

(57) ABSTRACT

An image forming apparatus according to an aspect of the present disclosure includes a communication unit, a display configured to display an operation image, a transmission processor, and a reception processor. The transmission processor transmits display information based on the operation image displayed on the display to the terminal device via the communication unit. The reception processor receives the first information related to the communication time which is necessary for the terminal device to acquire the display information, from the terminal device via the communication unit. The transmission processor transmits image information based on image quality information related to an image quality corresponding to the first information to the terminal device as the display information.

The present application is based on, and claims priority from JP Application Serial Number 2023-201434, filed Nov. 29, 2023, the disclosure of which is hereby incorporated by reference herein in its entirety.

### BACKGROUND

### 1. Technical Field

The present disclosure relates to an image forming apparatus, a terminal device, and a method of transmitting information.

### 2. Related Art

JP-A-2019-220075 discloses a system for stably and rapidly transferring a moving image on a remote panel, which is a function of displaying an operation unit of an image forming apparatus via a network, without depending on a line speed of a public line or a geographical situation of a line.

JP-A-2019-220075 is an example of the related art.

Incidentally, in the remote panel, the time it takes until the display of the remote panel is switched may be elongated in some cases regardless of the network configuration, which degrades the convenience. Note that the technology described in JP-A-2019-220075 is not a technology capable of solving such a problem.

Therefore, it is desired to develop a technique to shorten the time necessary to switch the display of the operation image when displaying a part or all of an operation image of the image forming apparatus from the terminal device via the network to perform an operation to thereby improve the convenience of the user.

### SUMMARY

An image forming apparatus according to an aspect of the present disclosure includes a communication unit, a display unit configured to display an operation image, a transmission processing unit configured to transmit display information based on the operation image displayed on the display unit to a terminal device via the communication unit, and a reception processing unit configured to receive first information related to a communication time necessary for communication for the terminal device to acquire the display information from the terminal device via the communication unit, wherein the transmission processing unit is configured to transmit, to the terminal device, image information based on image quality information related to an image quality corresponding to the first information as the display information.

A terminal device according to an aspect of the present disclosure includes an operation unit, a communication unit, a reception processing unit configured to receive display information based on an operation image displayed on an image forming apparatus-side display unit as a display unit of an image forming apparatus from the image forming apparatus via the communication unit, a display unit configured to display a remote operation image based on the display information received by the reception processing unit, a storage unit configured to store a communication time necessary for communication for acquiring the display information from the image forming apparatus, and a transmission processing unit configured to transmit first information related to the communication time to the image forming apparatus via the communication unit, wherein the reception processing unit is configured to receive image information based on image quality information related to an image quality corresponding to the first information as the display information from the image forming apparatus, and the display unit is configured to display the remote operation image based on the image information.

A method of transmitting information according to an aspect of the present disclosure includes executing, by an image forming apparatus including a communication unit and a display unit configured to display an operation image, transmission processing of transmitting display information based on the operation image displayed on the display unit to a terminal device via the communication unit, and executing, by the image forming apparatus, reception processing of receiving first information related to a communication time necessary for communication for the terminal device to acquire the display information from the terminal device via the communication unit, wherein in the transmission processing, image information based on image quality information related to an image quality corresponding to the first information is transmitted to the terminal device as the display information.

### BRIEF DESCRIPTION OF THE DRAWINGS

FIG. 1 is a block diagram illustrating a configuration example of an image forming system including an image forming apparatus and a terminal device according to an embodiment.

FIG. 2 is a flowchart illustrating a processing example of a terminal device in the image forming system in FIG. 1.

FIG. 3 is a flowchart illustrating a processing example of the image forming apparatus in the image forming system in FIG. 1.

FIG. 4 is a flowchart illustrating a processing example when an operation image the highest in image quality level is acquired in the terminal device of the image forming system in FIG. 1.

FIG. 5 is a flowchart illustrating a processing example when an operation image the lowest in image quality level is acquired in the terminal device of the image forming system in FIG. 1.

FIG. 6 is a schematic diagram showing an example of a remote operation image displayed on the terminal device in the processing example in FIG. 4.

FIG. 7 is a schematic diagram illustrating an example of a remote operation image medium in image quality level displayed on the terminal device in the image forming system in FIG. 1.

FIG. 8 is a schematic diagram illustrating an example of a remote operation image displayed on the terminal device in the processing example in FIG. 5.

FIG. 9 is a diagram illustrating examples of a communication data size, a communication time, and a performance improvement rate when the remote operation images in FIG. 6 to FIG. 8 are transmitted in the image forming system in FIG. 1.

FIG. 10 is a schematic block diagram illustrating another configuration example of the image forming system including the image forming apparatus and the terminal device according to the embodiment.

FIG. 11 is a diagram showing an example of a hardware configuration of an apparatus.

### DESCRIPTION OF EMBODIMENTS

An embodiment of the present disclosure will hereinafter be described with reference to the drawings. Note that the drawings are nothing more than illustrations describing the embodiment of the present disclosure. Further, all the elements described in the embodiment of the present disclosure are not necessarily essential elements of the present disclosure.

### EMBODIMENT

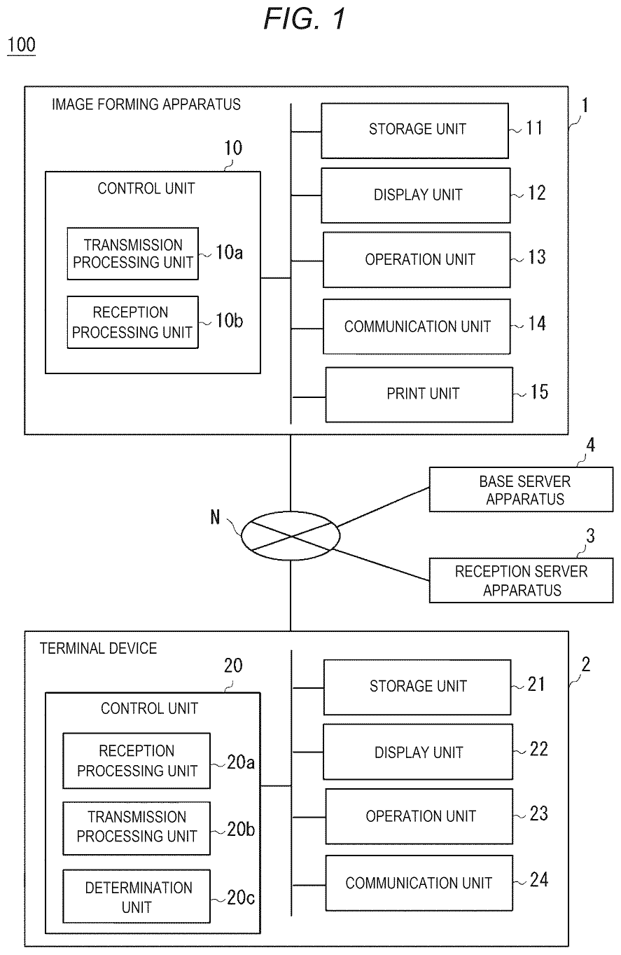

An image forming system including the image forming apparatus and the terminal device according to the embodiment will be described using FIG. 1. FIG. 1 is a block diagram illustrating a configuration example of such an image forming system.

As illustrated in FIG. 1, an image forming system (hereinafter referred to as the present system) 100 according to the present embodiment may include an image forming apparatus 1, a terminal device 2, a reception server apparatus 3, and a base server apparatus 4. The terminal device 2 may be coupled to the reception server apparatus 3 via a network N. Further, the reception server apparatus 3 may be coupled to the base server apparatus 4 via the network N. Further, the base server apparatus 4 may be coupled to the image forming apparatus 1 via the network N. Hereinafter, a description will be presented assuming that the present system 100 employs such a network configuration example.

Note that in FIG. 1, a network which couples the devices is represented by the same network N for the sake of simplification of the description, but a coupling configuration of the devices is not limited to this configuration, such as a configuration in which some or all of the devices are coupled to each other with different networks. Further, the present system 100 may employ a network configuration other than the network configuration example described above. For example, as long as the present system 100 includes the image forming apparatus 1 and the terminal device 2 coupled to the image forming apparatus via the network N, the present system 100 may adopt a configuration which is not provided with the reception server apparatus 3 and the base server apparatus 4. Further, the present system 100 may be a system in which the functions of the reception server apparatus 3 and the base server apparatus 4 are installed in the same server apparatus, or may be a system including three or more server apparatuses in which further function distribution are formed. That is, it is sufficient for the image forming apparatus 1 to have a configuration of performing communication with the terminal device 2 via at least one information processing apparatus such as at least one server apparatus. In this case, the terminal device 2 is configured to communicate with the image forming apparatus 1 via at least one information processing apparatus such as at least one server apparatus.

The present system enables the terminal device 2 to operate an operation image of the image forming apparatus 1. The operation image provided from the image forming apparatus 1 to the terminal device 2 as described above or the provision of the operation image may be referred to as a remote panel or the like. The reception server apparatus 3 may be a server apparatus that provides reception processing of an operation from the terminal device 2 to the terminal device 2. The base server apparatus 4 may be a server apparatus that provides the image forming apparatus 1 with processing of operating the operation image of the image forming apparatus 1 based on the operation which has been received by the reception server apparatus 3.

### Schematic Configuration of Image Forming Apparatus 1

As illustrated in FIG. 1, the image forming apparatus 1 may include a control unit 10, a storage unit 11, a display unit 12, an operation unit 13, a communication unit 14, and a print unit 15.

The control unit 10 of the image forming apparatus 1 may also be referred to as a controller, and performs overall control of the image forming apparatus 1. Although described later in detail, the control unit 10 may include a transmission processing unit 10a and a reception processing unit 10b.

The control unit 10 may include an arithmetic processing device such as a central processing unit (CPU) or a graphics processing unit (GPU), a working memory, and a storage device that stores a control program, parameters, and so on. The control unit 10 may also be implemented as a system on a chip (SoC). As is understood from these examples, the control unit 10 may be provided with a configuration in which the control program is stored in an executable state. Note that the control unit 10 may have a configuration in which the control program is stored as a circuit configuration such as a field-programmable gate array (FPGA), or may be configured as a dedicated circuit. The transmission processing unit 10a and the reception processing unit 10b can be implemented as the program described above. The program described above may include a program for realizing the functions of the transmission processing unit 10a and the reception processing unit 10b in cooperation with the storage unit 11, the display unit 12, the operation unit 13, and the communication unit 14. Alternatively, the program described above may include a program for realizing the functions of the transmission processing unit 10a and the reception processing unit 10b in cooperation with the storage unit 11, the display unit 12, the operation unit 13, the communication unit 14, and the print unit 15.

The storage unit 11 is, for example, a hard disk drive, a solid state drive, or other memory devices. A part of the memory provided to the control unit 10 may be regarded as the storage unit 11. The storage unit 11 may also be regarded as a part of the control unit 10.

The display unit 12 is a region for displaying information. The display unit 12 can display an operation image that is a user interface (UI) image as the information. This operation image can be stored in the storage unit 11. The display unit 12 is formed of, for example, a display device such as a liquid crystal display or an organic EL display. The display unit 12 may have a configuration including a display and a drive circuit for driving the display.

The operation unit 13 is a region that receives an operation or an input by a user, and may also be referred to as an operation reception unit. The operation unit 13 may include a touch panel or a touch sensor installed in the display unit 12. In this case, by the user performing a touch operation on the operation image displayed on the display unit 12, the operation unit 13 can receive an operation corresponding to the area where the touch operation is performed. Such the display unit 12 for displaying an operation image and such the operation unit 13 including the touch panel or the touch sensor installed in the display unit 12 can configure an operation panel of the image forming apparatus 1. Besides the above, the operation unit 13 may also include, for example, a physical button group. Some buttons of the physical button group may be configured to be capable of receiving an operation on the operation image. Obviously, some or all of the buttons of the physical button group may be configured to receive operations independent of the operation image.

The communication unit 14 may be a single communication interface or a plurality of communication interfaces for the image forming apparatus 1 to perform communication with a plurality of external apparatuses with wire or wirelessly in conformity with a predetermined communication protocol including a predetermined communication standard. The external apparatus is a device having a communication function such as a personal computer (PC), a server apparatus, a smartphone, or a tablet terminal. In the network configuration example described above, the external apparatus when performing communication regarding processing related to the operation image includes the base server apparatus 4 as a result.

The communication unit 14 can transmit display information for displaying the operation image in the terminal device 2 to the terminal device 2 via the base server apparatus 4 and the reception server apparatus 3. Note that the display information may be the operation image itself. The operation image to be displayed on the display unit 22 of the terminal device 2 based on the display information is hereinafter referred to as a remote operation image so as to be distinguished from the operation image to be displayed on the display unit 12. Further, the communication unit 14 can receive an operation event received by the terminal device 2 from the terminal device 2 via the reception server apparatus 3 and the base server apparatus 4.

In addition, the communication unit 14 can receive a print target file from the external apparatus. The external apparatus that transmits the print target file may be a terminal device other than the terminal device 2. Note that the communication unit 14 may be configured to be able to receive the print target file from the terminal device 2 directly or via the reception server apparatus 3 and the base server apparatus 4.

The print unit 15 performs printing on a medium based on, for example, a print target file received from the terminal device other than the terminal device 2 or the terminal device 2 via the communication unit 14, or a print target file obtained by performing image reading with a scanner (not shown). Thus, an image represented by the print target file is formed in the medium. A printing method in the print unit 15 does not matter, and various printing methods such as an inkjet printing method and a laser printing method can be applied. The image forming apparatus 1 may be referred to as an inkjet printer when the inkjet printing method is employed, and may be referred to as a laser printer when the laser printing method is employed.

### Schematic Configuration of Terminal Device 2

The terminal device 2 may be a device having a communication function such as a smartphone, a tablet terminal, or a PC. The terminal device 2 is not limited to a portable type device, and may be an installation type device. As illustrated in FIG. 1, the terminal device 2 may include a control unit 20, a storage unit 21, a display unit 22, an operation unit 23, and a communication unit 24.

The control unit 20 of the terminal device 2 may be referred to as a controller, and performs overall control of the terminal device 2. The control unit 20 may include a reception processing unit 20a, a transmission processing unit 20b, and a determination unit 20c although described later in detail.

The control unit 20 may include an arithmetic processing device such as a CPU or a GPU, a working memory, and a storage device that stores a control program, parameters, and so on. The control unit 20 may be configured as an SoC. As is understood from these examples, the control unit 20 may be provided with a configuration in which the control program is stored in an executable state. Note that the control unit 20 may be configured to store the control program as a circuit configuration such as an FPGA, or may be configured as a dedicated circuit. The reception processing unit 20a and the transmission processing unit 20b, or the reception processing unit 20a, the transmission processing unit 20b, and the determination unit 20c can be implemented as the program described above. The program described above may be a program for realizing the functions of the reception processing unit 20a and the transmission processing unit 20b, or the functions of the reception processing unit 20a, the transmission processing unit 20b, and the determination unit 20c in cooperation with the storage unit 21, the display unit 22, the operation unit 23, and the communication unit 24.

The storage unit 21 is, for example, a hard disk drive, a solid state drive, or other memory devices. A part of the memory provided to the control unit 20 may be regarded as the storage unit 21. The storage unit 21 can also be regarded as a part of the control unit 20.

The display unit 22 is a region for displaying information, and is configured with a display device such as a liquid crystal display or an organic EL display. The display unit 22 may have a configuration including a display and a drive circuit for driving the display.

The operation unit 23 is a region that receives an operation or an input by a user, and may also be referred to as an operation reception unit. The operation unit 23 can be realized by any one or more of, for example, physical buttons, a touch panel or a touch sensor installed in the display unit 22, a pointing device, a keyboard, and so on. In a configuration in which the operation unit 23 includes the touch panel or the touch sensor, the display unit 22 and the touch panel may collectively be referred to as an operation panel of the terminal device 2.

The communication unit 24 may be a single communication interface or a plurality of communication interfaces for the terminal device 2 to perform communication with a single external apparatus or a plurality of external apparatuses with wire or wirelessly in conformity with a predetermined communication protocol including a predetermined communication standard. In the network configuration example described above, the external apparatus when performing communication regarding processing related to the operation image includes the reception server apparatus 3 as a result.

The communication unit 24 can receive display information for causing the terminal device 2 to display a remote operation image, from the image forming apparatus 1 via the reception server apparatus 3 and the base server apparatus 4. As described above, the display information may be the remote operation image itself. Further, the communication unit 24 can transmit the operation event received by the operation unit 23 to the image forming apparatus 1 via the base server apparatus 4 and the reception server apparatus 3.

In addition, the communication unit 24 may be configured to be able to transmit the print target file to the image forming apparatus 1 directly or via the reception server apparatus 3 and the base server apparatus 4.

### Schematic Configuration of Reception Server Apparatus 3 and Base Server Apparatus 4

The reception server apparatus 3 and the base server apparatus 4 all may be server computers each provided with a function of receiving operations and a function of managing at least a remote panel, although the detailed description of each of the reception server apparatus 3 and the base server apparatus 4 is omitted. Any of the server computers may include a control unit, a communication unit, and a storage unit although not shown in the drawings.

This control unit may include an arithmetic processing device such as a CPU or a GPU, a working memory, and a storage device that stores a control program, parameters, and so on. This control unit may be configured as an SoC. As is understood from these examples, this control unit may be provided with a configuration in which the control program is stored in an executable state. Note that this control unit may be configured to store the control program as a circuit configuration such as an FPGA, or may be configured as a dedicated circuit.

The control unit of the reception server apparatus 3 receives the display information from the image forming apparatus 1 via the base server apparatus 4, and transmits the display information to the terminal device 2. Further, the control unit of the reception server apparatus 3 receives an operation event from the terminal device 2 and transmits the operation event to the image forming apparatus 1 via the base server apparatus 4. The control unit of the reception server apparatus 3 can implement such a function related to the transmission and the reception of the information as, for example, a program.

The control unit of the base server apparatus 4 receives the display information from the image forming apparatus 1, and transmits the display information to the terminal device 2 via the reception server apparatus 3. Further, the control unit of the base server apparatus 4 receives an operation event from the terminal device 2 via the reception server apparatus 3, and transmits the operation event to the image forming apparatus 1. The control unit of the base server apparatus 4 can implement these functions related to the transmission and the reception of the information as, for example, a program.

The communication unit described above may be a single communication interface or a plurality of communication interfaces for the server computer to perform communication with a single external apparatus or a plurality of external apparatuses with wire or wirelessly in conformity with a predetermined communication protocol including a predetermined communication standard. In the network configuration example described above, the communication unit in the reception server apparatus 3 can communicate with the terminal device 2 as the external apparatus and the base server apparatus 4. In the network configuration example described above, the communication unit in the base server apparatus 4 can communicate with the image forming apparatus 1 as the external apparatus and the reception server apparatus.

The storage unit described above is, for example, a hard disk drive, a solid state drive, or other memory devices. A part of the memory provided to the control unit described above may be regarded as this storage unit. In other words, the storage unit in the server computer can be regarded as a part of the control unit in the server computer.

In the network configuration example described above, the storage unit in the reception server apparatus 3 stores information for managing communication with the base server apparatus 4, information for managing communication with the specific terminal device 2, and so on. By managing the communication with the specific terminal device 2, it is possible to restrict access to the reception server apparatus 3 from a terminal device that is not stored, that is, an unregistered terminal device.

In the network configuration example described above, the storage unit in the base server apparatus 4 stores information for managing communication with the reception server apparatus 3, device information of the specific image forming apparatus 1, information for managing communication with the image forming apparatus 1, and so on. By managing communication with the specific image forming apparatus 1, it is possible to restrict access to the reception server apparatus 3 from the image forming apparatus that is not stored, that is, an unregistered image forming apparatus.

### Specific Configuration of Present System 100

Details of the control unit 10 of the image forming apparatus 1 will be described together with details of the terminal device 2. In the present system 100, as a general flow, the terminal device 2 accesses the reception server apparatus 3, receives display information based on the operation image displayed on the display unit 12 of the image forming apparatus 1, and causes the display unit 22 to display the remote operation image based on the display information. Then, the operation unit 23 of the terminal device 2 receives a user operation on the remote operation image, and transmits an operation event representing the user operation to the reception server apparatus 3. The reception server apparatus 3 transmits the operation event to the image forming apparatus 1 via the base server apparatus 4. The image forming apparatus 1 receives an operation on the operation image based on the operation event thus received, and thus, it is possible to change the operation image and the remote operation image by the transition to the next operation image and the next remote operation image, respectively, or the like.

First, a configuration example of the image forming apparatus 1 side will be described. As described above, the control unit 10 of the image forming apparatus 1 may include the transmission processing unit 10a and the reception processing unit 10b.

The transmission processing unit 10a transmits the display information based on the operation image displayed on the display unit 12 to the terminal device 2 via the communication unit 14. In the network configuration example described above, the transmission of such display information by the transmission processing unit 10a is executed via the base server apparatus 4 and the reception server apparatus 3. The display information is information displayed on a screen of the display unit 12, and can therefore also be referred to as screen information. Further, the display information can be displayed on the display unit 22 of the terminal device 2 using, for example, a Web browser, and in this case, the display information can also be referred to as Web screen information. As in this example, the transmission processing unit 10a may transmit the display information as information to be displayed on the browser of the terminal device 2.

The reception processing unit 10b receives the first information related to the communication time which is necessary for the terminal device 2 to acquire the display information, from the terminal device 2 via the communication unit 14. As will be described later, this first information is used to generate or select the display information for displaying the remote operation image. In the network configuration example described above, the reception of such first information by the reception processing unit 10b is executed via the reception server apparatus 3 and the base server apparatus 4. Note that the reception processing unit 10b may also be referred to as an acquisition processing unit since the reception processing unit 10b acquires the first information from the terminal device 2.

Further, the reception processing unit 10b may also be configured to receive the operation event received by the terminal device 2 from the terminal device 2 via the communication unit 14. In the network configuration example described above, the reception of such an operation event by the reception processing unit 10b is executed via the reception server apparatus 3 and the base server apparatus 4. This operation event is an event representing an operation received via the operation image displayed based on the display information transmitted to the terminal device 2.

It results in that the image forming apparatus 1 has a function of remotely providing an operation panel to the terminal device 2 by such transmission of the display information and reception of the operation event by the transmission processing unit 10a and the reception processing unit 10b, that is, a function of providing a remote panel. However, the operation of the operation image by the operation event is not essential in the present embodiment. In the present system 100, a system excluding the processing related to such an operation is a system that remotely monitors the operation image displayed on the display unit 12 of the image forming apparatus 1 out of the functions of the remote panel.

The transmission processing unit 10a in the present embodiment further has the following features. That is, the transmission processing unit 10a transmits the image information based on image quality information related to the image quality corresponding to the first information to the terminal device 2 as the display information. An example of processing in which the transmission processing unit 10a transmits the image information as the display information to the terminal device 2 will be described later. This processing is hereinafter referred to as image information transmission processing.

The image forming apparatus 1 can send back the display information corresponding to the first information by performing such reception of the first information and such transmission of the display information as a response thereto by the transmission processing unit 10a and the reception processing unit 10b, and make the terminal device 2 display the remote operation image based on the display information.

The image information transmission processing will be described. When the reception processing unit 10b receives the first information, it is preferable for the transmission processing unit 10a to detect the first information to execute the image information transmission processing. Alternatively, the reception processing unit 10b may be configured to receive, as the first information, information including a request related to the image quality information from the terminal device 2. In this case, when the reception processing unit 10b receives the first information including the request related to the image quality information, it is preferable for the transmission processing unit 10a to execute the image information transmission processing as a response to the request.

The image information to be the transmission target in the transmission processing unit 10a is information based on the image quality information related to the image quality corresponding to the first information. Further, the image information may be stored as the remote operation image in the storage unit 11, may be generated from the remote operation image, or may be generated from the operation image stored in the storage unit 11 to be displayed on the display unit 12. That is, it is preferable for the transmission processing unit 10a to generate or select the image information for displaying the remote operation image in the terminal device 2 based on the image quality information related to the image quality corresponding to the first information.

As described above, the first information is the information related to the communication time and may include the communication time itself. That is, the reception processing unit 10b may be configured to receive the information including the communication time as the first information from the terminal device 2. In this case, it is preferable for the transmission processing unit 10a to transmit, to the terminal device 2, the image information generated or selected based on the image quality information related to the image quality corresponding to the communication time thus received, as the image information transmission processing. Further, by associating the communication time and the image information with each other in advance, the transmission processing unit 10a can also transmit the image information generated or selected in accordance with the communication time to the terminal device 2, as the image information transmission processing.

Alternatively, the first information may be information including the image quality information determined based on the communication time. That is, the reception processing unit 10b may be configured to receive, from the terminal device 2, the information including the image quality information determined on the terminal device 2 side based on the communication time as the first information. In this case, it is preferable for the transmission processing unit 10a to transmit the image information generated or selected based on the image quality information thus received to the terminal device 2, as the image information transmission processing.

Then, a configuration example of the terminal device 2 side will be described. As described above, the control unit 20 of the terminal device 2 may include the reception processing unit 20a and the transmission processing unit 20b.

The reception processing unit 20a receives the display information based on the operation image displayed on the display unit 12 of the image forming apparatus 1 from the image forming apparatus 1 via the communication unit 24. In the network configuration example described above, the reception of such display information by the reception processing unit 20a is executed via the base server apparatus 4 and the reception server apparatus 3. Note that the reception processing unit 20a may also be referred to as an acquisition processing unit since the reception processing unit 20a acquires the display information from the image forming apparatus 1.

Then, the display unit 22 displays the remote operation image based on the display information received by the reception processing unit 20a. Further, as described above, the display information may be displayed on the display unit 22 using, for example, a Web browser. As in this example, the reception processing unit 20a may receive the display information as information to be displayed by the browser of the terminal device 2.

Further, the transmission processing unit 20b can also be configured to transmit the operation event received by the operation unit 23 to the image forming apparatus 1 via the communication unit 24. In the network configuration example described above, the transmission of such an operation event by the transmission processing unit 20b is executed via the reception server apparatus 3 and the base server apparatus 4. Examples of the operation event include an event of a click operation or a touch operation by a pointing device on the operation image displayed on the display unit 22. Note that the description will hereinafter be presented referring the pointing device to as a mouse, and referring the operation by the mouse to as a mouse operation.

It results in that the terminal device 2 is provided with a function of remotely enjoying the provision of the operation panel from the image forming apparatus 1 by such reception of the display information and transmission of the operation event by the reception processing unit 20a and the transmission processing unit 20b, that is, a function of enjoying the remote panel. However, as described above, the operation of the operation image by the operation event is not essential in the present embodiment.

The transmission processing unit 20b and the reception processing unit 20a in the present embodiment further have the following features. That is, the transmission processing unit 20b transmits the first information related to the communication time described above to the image forming apparatus 1 via the communication unit 24. For this purpose, the storage unit 21 stores the communication time described above in advance. This communication time is a time required for the communication for acquiring the display information from the image forming apparatus 1 as described above, and can be calculated from the communication start time and the communication end time at that time when the reception processing unit 20a actually tries to acquire the display information. An example of processing in which the transmission processing unit 20b transmits the first information to the image forming apparatus 1 will be described later. This processing is hereinafter referred to as first information transmission processing.

The reception processing unit 20a receives, from the image forming apparatus 1, image information based on the image quality information related to the image quality corresponding to the first information as the display information. It results in that the display unit 22 displays the remote operation image based on the image information received in such a manner. Obviously, it results in that the reception of the image information by the reception processing unit 20a is also executed via the communication unit 24. In the network configuration example described above, the reception of such image information by the reception processing unit 20a is also executed via the base server apparatus 4 and the reception server apparatus 3.

The terminal device 2 can display the remote operation image based on the display information corresponding to the first information on the display unit 22 by performing such transmission of the first information and such reception of the image information as the response thereto by the transmission processing unit 20b and the reception processing unit 20a.

The first information transmission processing will be described. In the configuration in which the first information is detected and then the image information transmission processing is executed when the reception processing unit 10b receives the first information in the image forming apparatus 1, it is sufficient for the first information transmission processing to be processing of simply transmitting the information related to the communication time as the first information. Alternatively, the transmission processing unit 20b may be configured to transmit, as the first information transmission processing, information including a request related to the image quality information to the image forming apparatus 1 as the first information. In this case, it results in that when the reception processing unit 10b receives the first information including the request related to the image quality information in the image forming apparatus 1, the transmission processing unit 10a executes the image information transmission processing as a response to the request.

As described above, the first information is the information related to the communication time and may include the communication time itself. That is, the transmission processing unit 20b may be configured to transmit, to the image forming apparatus 1, the information including the communication time as the first information, as the first information transmission processing. In this case, it results in that the transmission processing unit 10a of the image forming apparatus 1 transmits, to the terminal device 2, the image information generated or selected based on the image quality information related to the image quality corresponding to the communication time received therein, as the image information transmission processing. Then, it results in that the reception processing unit 20a receives the image information, and the display unit 22 displays the remote operation image based on the image information. Further, when the image forming apparatus 1 associates the communication time and the image information with each other in advance, the transmission processing unit 10a of the image forming apparatus 1 can transmit the image information generated or selected in accordance with the communication time to the terminal device 2 as the image information transmission processing. Then, it results in that the reception processing unit 20a receives the image information, and the display unit 22 displays the remote operation image based on the image information.

Alternatively, the first information may be information including the image quality information determined based on the communication time. For such a determination, it is preferable for the control unit 20 to include the determination unit 20c. It is preferable for the determination unit 20c to determine the image quality information based on the communication time stored in the storage unit 21. Then, it is preferable for the transmission processing unit 20b to transmit, to the image forming apparatus 1, the information including the image quality information as the first information, as the first information transmission processing.

### Processing Example of Present System 100

The configurations of the image forming apparatus 1 and the terminal device 2 are described hereinabove. Then, processing in which the remote operation image is changed in accordance with the first information in the configuration described above will be explained citing a specific example.

The reception processing unit 20a in the terminal device 2 can be configured to receive the image information lower in image quality than when the communication time is equal to or shorter than a predetermined time from the image forming apparatus 1 when the communication time is longer than the predetermined time. When viewed from the image forming apparatus 1 side, the transmission processing unit 10a can be configured to transmit the image information lower in image quality than when the communication time is equal to or shorter than the predetermined time described above to the terminal device 2 when the communication time is longer than the predetermined time described above.

Such determination processing in which the predetermined time described above is used as a threshold value may be executed at the terminal device 2 side or may be executed at the image forming apparatus 1 side. It is sufficient, for example, for the determination unit 20c to execute the determination processing in which the predetermined time is used as the threshold value, and for the transmission processing unit 20b to transmit the first information to the image forming apparatus 1 side based on the determination result thereof. Alternatively, the transmission processing unit 10a of the image forming apparatus 1 may execute the determination processing in which the predetermined time is used as the threshold value.

By adopting such determination processing, the present system 100 can automatically degrade the image quality of the remote operation image displayed on the display unit 22 when the time required for acquiring the image information from the image forming apparatus exceeds the predetermined time. As a result, the present system 100 can reduce the communication data amount to perform efficient communication.

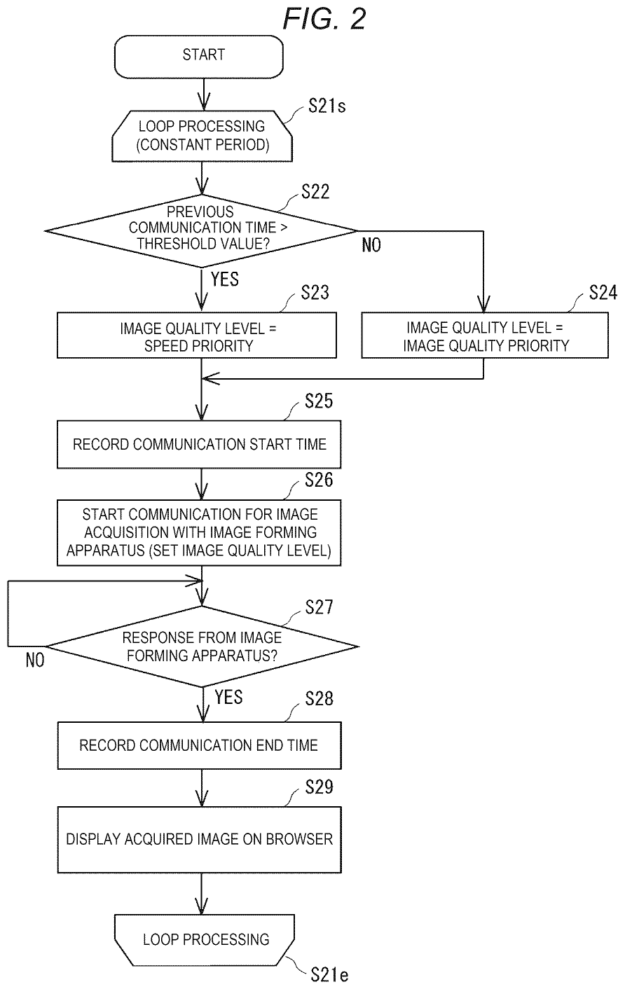

A flow of processing of the terminal device 2 with such determination processing will be described using FIG. 2. FIG. 2 is a flowchart illustrating a processing example of the terminal device 2 in the present system 100. The processing example in FIG. 2 represents an example of update processing in which the remote operation image with respect to the operation image displayed in the image forming apparatus 1 is periodically updated in the terminal device 2. Here, an example in which the image information transmitted from the image forming apparatus 1 is a remote operation image to be displayed on a browser that can be displayed on the display unit 22 of the terminal device 2 will be cited.

As the update processing, the terminal device 2 performs loop processing of the processing represented by steps S22 to S29 at a constant period (steps S21s to S21e). This period is not limited, but may be, for example, an interval of 0.3 second to 0.5 second.

In this loop processing, first, the determination unit 20c retrieves the communication time required to acquire the previous image information from the storage unit 21, and determines whether the communication time exceeds a threshold value using the predetermined time described above as the threshold value (step S22).

When YES is determined in step S22, the determination unit 20c determines the image quality level requested to the image forming apparatus 1 side as a speed priority level (step S23). The predetermined time described above may be determined in advance as, for example, 0.5 second. In this case, when it takes more than 0.5 second to acquire the image, it is considered that the environment is low in communication speed, and the processing in step S23 can be executed. Here, the speed priority level may be such a level that the communication speed is prioritized and a deterioration of the image quality of the remote operation image is allowed. For example, when the image quality level can be changed in increments of 1 with a minimum value of 1 and a maximum value of 10, it is sufficient for the speed priority level to be determined in advance as, for example, 3 in the image quality level. Accordingly, when the environment is low in communication speed, by deteriorating the image quality of the remote operation image to reduce the data size thereof, the communication time associated therewith can be reduced to perform the efficient communication.

On the other hand, when NO is determined in step S22, the determination unit 20c determines the image quality level requested to the image forming apparatus 1 side to be an image quality priority level (step S24). Here, the image quality priority level may be such a level that the image quality of the remote operation image is prioritized and a decrease in the communication speed is allowed. For example, in the example described above in which the image quality level can be changed from 1 to 10, the image quality priority level may be determined in advance as, for example, 10 in the image quality level.

After the processing in step S23 or after the processing in step S24, the reception processing unit 20a or the transmission processing unit 20b records the communication start time in the storage unit 21 (step S25). In step S25, for example, the communication start time can be recorded as a variable on the browser. The communication start time recorded in step S25 can be used to obtain the time required to acquire the remote operation image, that is, the communication time.

Then, the transmission processing unit 20b starts communication for transmitting the information for requesting image acquisition to the image forming apparatus 1 as the first information in a state where the image quality information is designated as a parameter (step S26). This communication is communication for the image acquisition to be performed together with the image forming apparatus 1. Further, the image quality information mentioned here can be exemplified by the image quality level described above. Therefore, in step S26, it is preferable to set the image quality level determined in step S23 or step S24 to be included as at least one parameter of the first information to perform the transmission. Note that the order of step S25 and step S26 does not matter.

Then, the reception processing unit 20a determines whether there is a response from the image forming apparatus 1 (step S27). This response is, for example, a reply of the remote operation image. When NO is determined in step S27, this response is awaited.

At the stage in which YES is determined in step S27, the reception processing unit 20a records the communication end time in the storage unit 21 (step S28). In step S28, for example, the communication end time can be recorded as a variable on the browser. The communication end time recorded in step S28 can be used to obtain the time required to acquire the remote operation image, that is, the communication time. This communication time is stored in the storage unit 21 together with the communication start time recorded in step S25, and can be referred to at the time of the determination in step S22.

After step S28, the reception processing unit 20a displays the remote operation image acquired by the response thereof on the browser (step S29). Note that the order of step S28 and step S29 does not matter.

As described with reference to FIG. 2, the terminal device 2 can periodically perform image update in the background in order to display a change in the operation image of the image forming apparatus 1 in real time as the remote operation image even when there is no operation by the user. Since the communication time required for such periodic image update processing is also recorded in combination, the determination processing based on the communication time can be performed.

Further, the communication time may be recorded as a communication time when requesting a remote operation image of a predetermined data amount or within a range of the predetermined data amount such as a communication time when requesting the remote operation image in a predetermined image quality level. The predetermined image quality level described above may be the highest image quality level. Alternatively, in the determination processing of determining the communication time about a threshold value, the threshold value may be changed in accordance with the image quality level or in accordance with the data amount. Alternatively, the communication time may be calculated as the communication time per data amount to leave the threshold value fixed. Further, although the communication time has been described on the assumption that it is time required for a single communication, it is also possible to use a statistical value such as an average value of a predetermined number of times thereof or a maximum value of a predetermined number of times thereof.

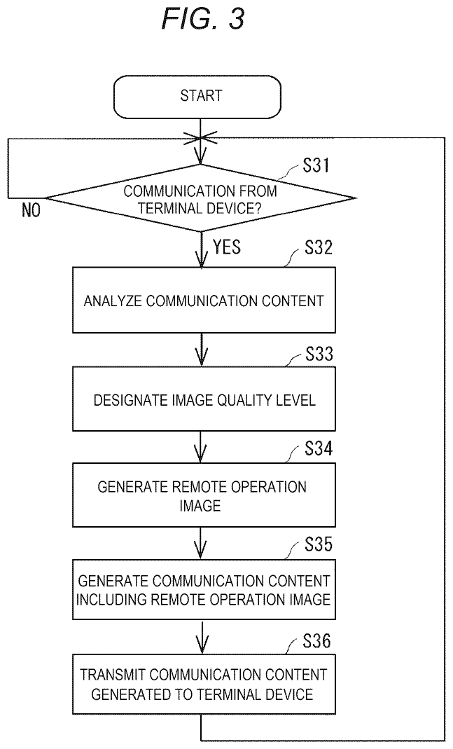

Then, a flow of processing of the image forming apparatus 1 executed corresponding to the processing of the terminal device 2 as described above will be described using FIG. 3. FIG. 3 is a flowchart illustrating a processing example of the image forming apparatus 1 in the present system 100.

First, the reception processing unit 10b of the image forming apparatus 1 determines whether there is the communication from the terminal device 2 (step S31). When there is no communication, the communication is awaited. When there is the communication, that is, when YES is determined in step S31, the reception processing unit 10b analyzes (step S32) the communication content. This analysis also includes extraction of the image quality level contained in the first information described above.

Upon reception of the analysis result, the transmission processing unit 10a designates the image quality level of the remote operation image to be transmitted to the terminal device 2 (step S33). Then, the transmission processing unit 10a generates the remote operation image in the image quality level thus designated (step S34). Note that as described above, in step S34, the remote operation image corresponding to the image quality level may be selected from the image group stored in advance. Further, the transmission processing unit 10a generates the communication content including the remote operation image thus generated (step S35). Then, the transmission processing unit 10a transmits the communication content thus generated to the terminal device 2 (step S36). After step S36, it results in that the process returns to step S31 and the next communication from the terminal device 2 is awaited.

Note that in FIG. 2 and FIG. 3, only an example in which the determination processing is executed at the terminal device 2 side is described. On the other hand, when the determination processing is performed at the image forming apparatus 1 side, for example, when analyzing the communication content in step S32, it is sufficient to determine whether the communication time is longer than the threshold value from the first information related to the communication time. Then, it is sufficient to designate the image quality level in accordance with the determination result in step S33.

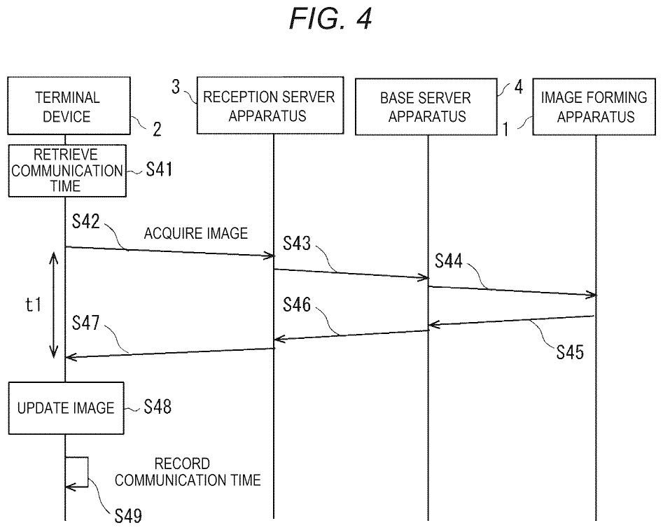

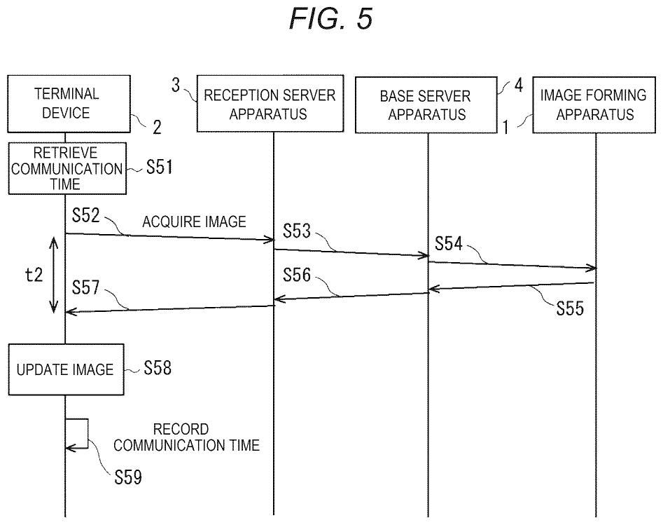

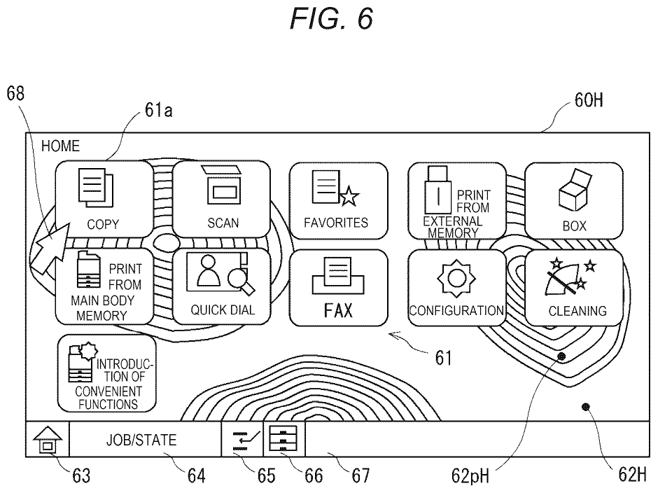

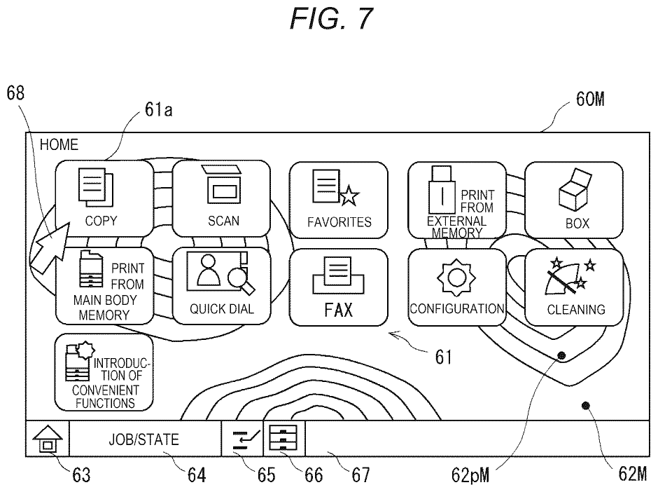

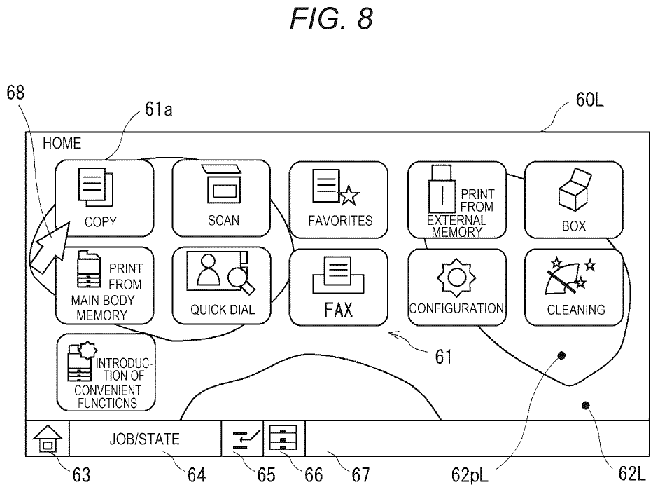

Then, using FIG. 4 to FIG. 8, a description of an example of overall processing related to the update of the remote operation image in the present system 100 will be presented citing examples of the remote operation image. FIG. 4 is a flowchart illustrating a processing example when a remote operation image the highest in image quality level is acquired in the terminal device 2 of the present system 100. FIG. 5 is a flowchart illustrating a processing example when a remote operation image the lowest in image quality level is acquired in the terminal device 2 of the present system 100. Further, FIG. 6 is a schematic diagram illustrating an example of the remote operation image the highest in image quality level displayed on the terminal device 2 in the processing example in FIG. 4. FIG. 7 is a schematic diagram illustrating an example of a remote operation image medium in image quality level displayed on the terminal device 2 in the present system 100. FIG. 8 is a schematic diagram illustrating an example of the remote operation image the lowest in image quality level displayed on the terminal device 2 in the processing example in FIG. 5.

First, by receiving the provision of the remote panel, the terminal device 2 retrieves, from the storage unit 21, the communication time when the provision was received (step S41). This communication time is preferably set as, for example, a previous communication time, but at first, this communication time is sufficiently set as a default value.

Then, the terminal device 2 sets the image quality level in accordance with the communication time, and requests the reception server apparatus 3 to acquire the remote operation image (step S42). In FIG. 4, an example in which the communication time is shorter than a predetermined time and the image quality level is set to 10 is cited. Therefore, in the request in step S42, as a result, the acquisition of a remote operation image 60H in FIG. 6, which is the remote operation image in the highest image quality level of 10, is requested. The remote operation image 60H will be described later.

The reception server apparatus 3 which received the request to acquire the remote operation image transmits the request to the base server apparatus 4 (step S43). The base server apparatus 4 which received the request transmits the request to the image forming apparatus 1 (step S44).

The image forming apparatus 1 generates a remote operation image for the terminal device 2 in accordance with the image quality level of 10, and transmits the remote operation image to the base server apparatus 4 (step S45). In this example, the remote operation image 60H corresponding to the image quality level of 10 is generated. The base server apparatus 4 which received the image information transmits the communication content including the remote operation image 60H to the reception server apparatus 3 (step S46). The reception server apparatus 3 that received the communication content transmits the communication content to the terminal device 2 (step S47).

The terminal device 2 displays the remote operation image 60H based on the communication content thus received (step S48). When some remote operation image was displayed in advance in step S41, the remote operation image is updated to the remote operation image 60H in step S48.

The remote operation image 60H may include a background image 62H including a gradation pattern 62pH. Further, the remote operation image 60H may include an icon group 61 representing functions such as copy and scan in the image forming apparatus 1. The icon group may include, for example, an icon 61a of a copy function. In addition, the remote operation image 60H may include a home button 63 that returns to a home image when it is not the home image. Further, the remote operation image 60H may include a button 64 for making the transition to the operation image representing a current state of a print job or the image forming apparatus 1, a button 65 for performing interrupt processing, a button 66 for selecting a tray of the medium, and an information field 67 for displaying various kinds of information. Obviously, the example of the remote operation image 60H is not limited thereto, and other buttons may be displayed, or an image that does not include some or all of the illustrated buttons, icons, and so on may be adopted as long as the image is an operation image. Further, in FIG. 6, an example in which a cursor 68 of the mouse is displayed at a predetermined position in the remote operation image 60H, and the mouse operation is enabled is cited.

Then, the terminal device 2 records a communication time t1 it takes until the update (step S49). Note that the order of steps S48, S49 does not matter. It results in that the processing described above is repeated, and the image quality level of the remote operation image displayed on the display unit 22 can be changed in accordance with the communication time retrieved in step S41.

For example, as a result of the determination in step S22 in FIG. 2, when the image quality level is set to the image quality level of 3 as the speed priority level as in step S23, a remote operation image 60M in FIG. 7 is displayed. Further, two or more threshold values may be provided, and when the communication time is shorter, a remote operation image 60L in FIG. 8, which is a remote operation image in the image quality level of 1 as the lowest image quality, may be displayed. In this case, as shown in FIG. 5, substantially the same processing as in steps S41 to S49 in FIG. 4 is executed (steps S51 to S59), but it results in that in step S52, the acquisition of the remote operation image is requested in a state where the image quality level is set to 1. In this case, a communication time t2 recorded in step S59 becomes shorter than the communication time t1 described above.

Further, the remote operation image 60M may include a background image 62M including a gradation pattern 62pM, and other objects may be substantially the same as in the remote operation image 60H. The remote operation image 60L may include a background image 62L including a gradation pattern 62pL, and other objects may be substantially the same as in the remote operation image 60H. In FIG. 6 to FIG. 8, it is understood that the gradation patterns 62pH, 62pM, and 62pL are coarser in resolution in this order.

An example in which only the background image is changed in accordance with the image quality level is cited here, but the resolution of the icon may be changed. Further, although the change in the image quality level of the background image is exemplified by the change in the resolution of the gradation pattern, the change in other visual effects may be adopted. Further, the resolution of the icon, the resolution of the gradation patterns of the background image, and other visual effects may be individually determined in advance in accordance with the first information as parameters of the image quality level.

Further, when an operation event is transmitted to the image forming apparatus 1 side in the terminal device 2, the operation event is updated to a remote operation image corresponding to the operation event. Also in this case, the update of the remote operation image described with reference to FIG. 4 to FIG. 8 can similarly be applied.

### Advantage of Present Embodiment

According to the present embodiment, it is possible to shorten the time necessary to switch the display of the remote operation image regardless of the network configuration when displaying a part or all of an operation image of the image forming apparatus 1 from the terminal device 2 via the network to perform an operation to thereby improve the convenience of the user. This is because, in the present embodiment, efficient communication is possible by changing the data amount of the remote operation image in accordance with the communication time. Further, as described above, since the operation event can be transmitted from the terminal device 2 to the image forming apparatus 1 side, it can be said that the reaction speed to such an operation event, that is, the reaction speed to the operation of the remote panel, can also be improved.

Therefore, according to the present embodiment, even in a network environment in which the communication speed is low such as when the communication path between the terminal device 2 and the image forming apparatus 1 is long regardless of their physical positions, it is possible to improve the display switching speed and so on of the remote panel to the user operation. In particular, according to the present embodiment, it is possible to improve the display switching speed of the remote panel to the user operation only by changing the programs of the terminal device 2 and the image forming apparatus 1 without requiring hardware costs such as an enhancement of the server apparatus and the communication line. Further, since the administrator or the like can determine in advance which image quality level is to be set as the lowest image quality level, it is also possible to provide only a remote operation image in an image quality level that ensures at least visibility at the image forming apparatus 1 side.

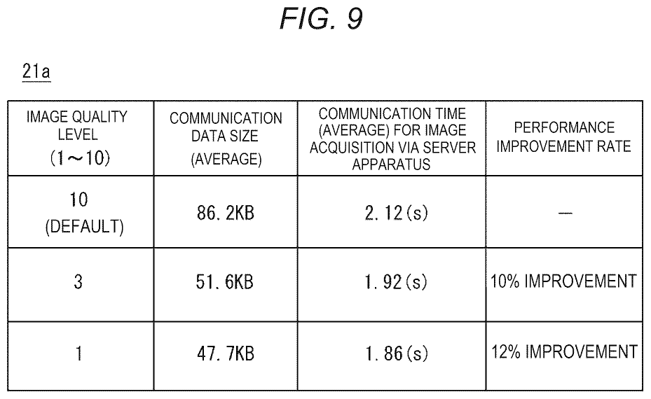

Then, the results of tests conducted under a predetermined system environment will be shown. As the predetermined system environment, the tests were conducted in an environment in which the communication path between the terminal device 2 and the image forming apparatus 1 is such a very long communication path as to extend from Japan via the overseas reception server apparatus 3 and base server apparatus 4. FIG. 9 is a diagram illustrating examples of a communication data size, a communication time, and a performance improvement rate when the remote operation images in FIG. 6 to FIG. 8 are transmitted in the present system 100. Here, the performance improvement rate refers to an improvement rate of the frame rate.

As a result, as shown in FIG. 9, for example, an improvement in performance of 10% was observed in the remote operation image 60M in the image quality level of 3 to the remote operation image 60H in the image quality level of 10 set as the default. Further, a performance improvement of 12% was observed in the remote operation image 60L in the image quality level of 1 to the remote operation image 60H. As described above, in the present system 100, even in the environment low in the communication speed, the frame rate of the remote panel can be improved by about 10 to 12% while ensuring the visibility of the remote operation image and preventing a hardware cost.

Then, an application scene of the present system 100 will be described to describe that the advantages described above are beneficial. The provision of the remote panel can be used by, for example, an operator who is far away from the image forming apparatus 1. Examples of the operator include an IT (Information Technology) administrator, a serviceman, and a reseller engineer. These operators can perform troubleshooting and training for end users without visiting the site where the image forming apparatus 1 is installed. For example, as a scene in which the remote panel is used, the following scenes (1) and (2) can be assumed.
(1) An IT administrator in a company in which the image forming apparatus 1 is installed uses the terminal device 2 to directly access and use the image forming apparatus 1 from the same intranet.
(2) A serviceman or a reseller engineer outside the company in which the image forming apparatus 1 is installed uses the terminal device 2 to access and use the image forming apparatus 1 via the reception server apparatus 3 and the base server apparatus 4.

In the present embodiment, in any of the scenes (1) and (2), the operator can comfortably and quickly perform processing by using the present system 100 high in display switching speed of the remote panel.

### Another Network Configuration Example of Image Forming System

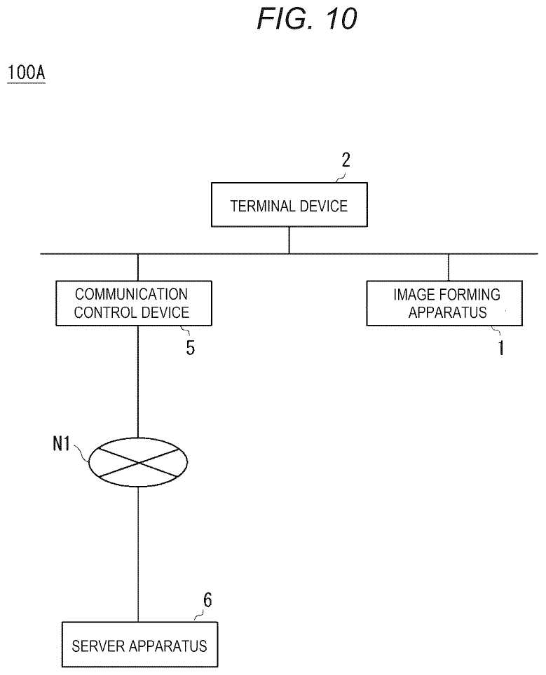

Another configuration example of the image forming system according to the present embodiment will be described using FIG. 10. FIG. 10 is a schematic block diagram illustrating another configuration example of the image forming system including the image forming apparatus and the terminal device according to the present embodiment.

The image forming system according to the present embodiment may be an image forming system 100A having a network configuration example as shown in FIG. 10. In the image forming system 100A, the terminal device 2 and the image forming apparatus 1 are coupled with a LAN (Local Area Network), and a communication control device 5 such as a router is coupled to the LAN. The LAN may be, for example, a LAN of a company in which the image forming apparatus 1 is installed. The communication control device 5 is a device that controls communication between devices in the LAN and a network N1. To the network N1, server apparatuses 6 such as the reception server apparatus 3 and the base server apparatus 4 are coupled. Obviously, the network configuration that can be applied in the present embodiment is not limited to those illustrated in FIG. 1 and FIG. 10.

### Other Modified Examples

The present disclosure is not limited to the embodiment described above, and can appropriately be modified without departing from the scope of the present disclosure. For example, the image forming apparatus applied to the image forming system according to the present embodiment can widely be applied to a copy machine, a facsimile machine, a composite machine provided with these functions, and so on, as can be understood from the remote operation images in FIG. 6 to FIG. 8 and so on.

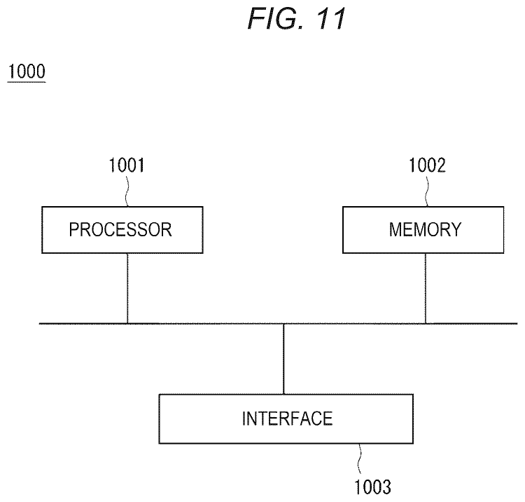

Further, the apparatuses provided to the image forming system according to the embodiment described above may include, for example, the following hardware configuration. FIG. 11 is a diagram showing an example of a hardware configuration of an apparatus.

An apparatus 1000 illustrated in FIG. 11 may include a processor 1001, a memory 1002, and an interface 1003. The interface 1003 may include, for example, a communication interface, a sensor, and an interface with an input-output device, which are necessary depending on the apparatus.

The processor 1001 may be, for example, a CPU, a GPU (Graphics Processing Unit), or an MPU (Micro Processor Unit) also referred to as a microprocessor. The processor 1001 may include a plurality of processors. The memory 1002 is formed of, for example, a combination of a volatile memory and a nonvolatile memory. Functions of the apparatuses are implemented by the processor 1001 reading a program stored in the memory 1002 and executing the program while exchanging necessary information via the interface 1003.

Further, the program described above includes an instruction group (or a software code) for causing a computer to implement one or more functions described in the embodiment when loaded into the computer. The program may be stored in a non-transitory computer-readable medium or a tangible storage medium. Examples of the computer-readable medium or the tangible storage medium include, but are not limited to, a random-access memory (RAM), a read-only memory (ROM), a flash memory, a solid-state drive (SSD), and other memory techniques. Further, examples of the computer-readable medium or the tangible storage medium include, but are not limited to, a CD-ROM, a digital versatile disc (DVD), a Blu-ray (registered trademark) disc, other optical disc storage, a magnetic cassette, a magnetic tape, a magnetic disk storage, or other magnetic storage devices. The program may be transmitted on a transitory computer-readable medium or a communication medium. Examples of the transitory computer-readable medium or the communication medium include, but are not limited to, electrical, optical, acoustic or other forms of propagation signals.

Although the present disclosure is described hereinabove with reference to the above embodiment, the present disclosure is not limited only to the configuration of the above embodiment, and the present disclosure obviously includes various variations, modifications, and combinations that can be made by those skilled in the art within the scope of the disclosure set forth in the appended claims of the present application.

What is claimed is:

1. An image forming apparatus comprising:
a communication unit;
a display configured to display an operation image;
a transmission processor configured to transmit display information based on the operation image displayed on the display to a terminal device via the communication unit; and
a reception processor configured to receive first information related to a communication time necessary for communication for the terminal device to acquire the display information from the terminal device via the communication unit, wherein
the transmission processor is configured to transmit, to the terminal device, image information based on image quality information related to an image quality corresponding to the first information as the display information.

2. The image forming apparatus according to claim 1, wherein
the reception processor is configured to receive, from the terminal device, information including a request related to the image quality information as the first information.

3. The image forming apparatus according to claim 1, wherein
the reception processor is configured to receive, from the terminal device, information including the communication time as the first information.

4. The image forming apparatus according to claim 1, wherein
the reception processor is configured to receive, from the terminal device, information including the image quality information determined based on the communication time as the first information.

5. The image forming apparatus according to claim 1, wherein
when the communication time is longer than a predetermined time, the transmission processor transmits, to the terminal device, the image information lower in image quality than the image information when the communication time is equal to or shorter than the predetermined time.

6. The image forming apparatus according to claim 1, wherein
the transmission processor is configured to transmit the display information as information to be displayed on a browser of the terminal device.

7. The image forming apparatus according to claim 1, wherein
the communication unit is configured to communicate with the terminal device via at least one information processing device.

8. A terminal device comprising:
an operation unit;
a communication unit;
a reception processor configured to receive display information based on an operation image displayed on an image forming apparatus-side display as a display of an image forming apparatus from the image forming apparatus via the communication unit;
a display configured to display a remote operation image based on the display information received by the reception processor;
a storage configured to store a communication time necessary for communication for acquiring the display information from the image forming apparatus; and
a transmission processor configured to transmit first information related to the communication time to the image forming apparatus via the communication unit, wherein
the reception processor is configured to receive image information based on image quality information related to an image quality corresponding to the first information as the display information from the image forming apparatus, and
the display is configured to display the remote operation image based on the image information.

9. The terminal device according to claim 8, wherein
the transmission processor is configured to transmit information including a request related to the image quality information to the image forming apparatus.

10. The terminal device according to claim 8, wherein
the transmission processor is configured to transmit, to the image forming apparatus, information including the communication time as the first information.

11. The terminal device according to claim 8, further comprising:
a determination unit configured to determine the image quality information based on the communication time, wherein
the transmission processor is configured to transmit, to the image forming apparatus, information including the image quality information as the first information.

12. The terminal device according to claim 8, wherein
when the communication time is longer than a predetermined time, the reception processor receives, from the image forming apparatus, the image information lower in image quality than the image information when the communication time is equal to or shorter than the predetermined time.

13. The terminal device according to claim 8, wherein
the reception processor is configured to receive the display information as information to be displayed on a browser of the terminal device.

14. The terminal device according to claim 8, wherein
the communication unit is configured to communicate with the image forming apparatus via at least one information processing device.

15. A method of transmitting information comprising:
executing, by an image forming apparatus including a communication unit and a display configured to display an operation image, transmission processing of transmitting display information based on the operation image displayed on the display to a terminal device via the communication unit; and
executing, by the image forming apparatus, reception processing of receiving first information related to a communication time necessary for communication for the terminal device to acquire the display information from the terminal device via the communication unit, wherein
in the transmission processing, image information based on image quality information related to an image quality corresponding to the first information is transmitted to the terminal device as the display information.
